(19) United States
(12) Patent Application Publication
(10) Pub. No.: US 2025/0371471 A1
(43) Pub. Date: Dec. 4, 2025

(54) Flexible tablet dispensing, inspection and packaging systems

(71) Applicant: VMI Holland B.V., Epe (NL)

(72) Inventors: Patrick van Voorn, Epe (NL); Rogier Scheide, Epe (NL)

(73) Assignee: VMI Holland B.V., Epe (NL)

(21) Appl. No.: 18/876,201

(22) PCT Filed: Aug. 10, 2023
(86) PCT No.: PCT/EP2023/072227

§ 371 Date: Dec. 18, 2024

Related U.S. Application Data
(60) Provisional application No. 63/396,983, filed on Aug. 11, 2022.

(51) Int. Cl. G06Q 10/0633; A61J 7/00; B65B 5/10; B65B 57/14; G06Q 10/0631

(52) U.S. Cl. CPC G06Q 10/06334; A61J 7/0084; B65B 5/103; B65B 57/14; G06Q 10/06312; G06Q 10/06313

(57) ABSTRACT

A method of dynamically ordering tasks in a production system comprises providing a control unit configured to: receive a plurality of job orders; determine tasks associated with each of the plurality of job orders; dynamically adjust the priority of each job order in a pending job orders list; and send one of the job orders and associated tasks to a queue when a threshold associated with the system is met.

### BACKGROUND

Medicine or tablet dispensing and packaging systems (e.g., into pouches and/or blister packs) typically involve hardware and software for the various processes and systems, including the planning, execution, inspection/correction, and packaging/shipping to the customer. One such tablet dispensing device is shown in U.S. Patent App. Pub. No. 2014/0366489 A1, which is hereby incorporated by reference. The hardware can include various machines and/or stations to perform all or parts of the overall process, including forming the pouches, dispensing the tablets into the pouches, inspecting the pouches for defects, correcting or flagging any defects, ensuring medicines are available and ready to be placed in the pouches, dispatching to the end users, and devices to transfer between systems (e.g., robots, conveyors, etc.).

Some systems involve doing certain parts of the processes manually, for example, instructing an operator when certain parts of the process (e.g., visual inspection and correction of certain pouches) need to be done and/or instructing an operator to manually prepare a plate of certain medicines for a table dispenser to dispense into a pouch. The discrete components of systems (dispenser device, inspection station, etc.) typically have individual control systems which could typically sent messages to other components but were not designed to interact and/or consider more than their specific components and tasks. These different components then needed to be connected so they could each do part of the process and send the results to the next component. The way orders are handled in such systems was typically to store all incoming orders in a database. When the first system was ready and available, it would query the database for the next order or task, for example, dispensing a combination of two types of tablets to form 10 pouches, each containing one tablet. If the order included tablets which need manual preparation (e.g., the first tablet), the tray preparation system would query the database when it was ready for a further task and the task would be then sent to the tray preparation system. The tray would be prepared and the packaging system would wait for the tray during preparation. This system sometimes resulted in delayed processes, for example, when the tablets were not immediately available for use and all systems simply needed to wait until that was done to continue with the preparation and packaging.

Past systems also typically had a standard process configuration, though may be able to configure various devices mechanically differently according to customer needs.

### SUMMARY OF THE INVENTION

The device in US 2014/0366489 A1 is great at continuously dispensing, collecting and packing solid substances as long as the feeder units are reliably dispensing said solid substances and any manual plate-fill medication is provided. However, when one of the feeder units is unexpectedly unable to dispense solid substances, for example because the solid substances held in said respective feeder unit have been depleted, when the remaining solid substances are not easily dispensed for some reason or when the remaining solid substances are past their expiry date, the dispensing is interrupted. Additionally, if the manual filling of a plate takes a long amount of time or is delayed, dispensing can also be delayed.

One method of avoiding delays in dispensing is to queue up orders and tasks, for example, when a number of job orders are received at the device, the dispensing machine typically lines up the job orders for processing and fulfilling in the order they are received. Once the associated tasks (e.g., plate filling, refilling of cannisters) for each job are known or determined, the job order and associated tasks are put in a queue such the various systems and operator(s) always have a running list of what to work on next once one task/job is finished. This helps with efficiency and minimizing downtime of the overall system.

However, various things happen during production which can cause the priority of job orders to change in the time between when they are received and the time when the system starts to fulfill the job order. For example, it may be determined that a specific job order needs to have a shipping time earlier than previously thought (e.g., due to weather conditions affecting shipment). Other things that could affect ordering of jobs include, but are not limited to: tablets for a specific job order being not be available until a later moment or expired, that a job order requires a lot of manual plate filling and only one operator is available at certain times for the system, breakdown of certain components needed for specific orders, scheduling of operators, a new urgent job order is received, dispensing resources or equipment availability, etc. In such instances, it would make sense to change the priority of job orders and tasks. However, there is no ability to change the priority or order once tasks are in the queue.

Thus, it is an object of the present invention to provide a method, a computer program product and system for a production system, wherein the order of jobs and/or tasks can be dynamically adjusted as needed or desired while also minimizing the downtime and delay of the overall system and job order fulfillment. Such a system can essentially throttle the job orders, dynamically reprioritizing them until the last possible moment before they need to be sent to the queue for order fulfillment.

In the context of this application, the term queue is used to denote a linear list of items (e.g., job orders or tasks) in which all additions are at one end of the queue (e.g., the bottom) and all deletions (e.g., completions) are at the other opposite end of the queue (e.g., the top). Once items or tasks are placed in the queue at one end, they cannot be reordered and no changes in the order of the queue can be made except to delete items at the other end of the queue. Some queues are prioritized queues which add the element of priority to the item, but this has to be added to the item before entering the queue and cannot be changed once the item is in the queue.

According to a first aspect of the invention, a method of dynamically ordering tasks in a production system is provided. The method comprises providing a control unit configured to: receive a plurality of job orders; determine tasks associated with each of the plurality of job orders; dynamically adjust the priority of each job order in a pending job orders list; and send one of the job orders and associated tasks to a queue when a threshold associated with the system is met. Such a method provides a way for adjusting priorities in a production system while also ensuring any downtime is minimised by always providing a queue of tasks ready for providing the next task which must be done as soon as the previous one has been completed, but also not sending the tasks to the queue (where they cannot be reprioritized) until a late moment.

According to an embodiment, the threshold associated with the system comprises a set number of tasks in the queue related to the amount of operators currently working. This can be, for example, two tasks per operator when the tasks are expected to take a substantial amount of time (e.g., 5+ minutes per task).

Optionally or alternatively, the threshold associated with the system comprises a number of tasks which are estimated to take a total predetermined amount of time in the queue. For example, the queue should always be filled with 5-10 minutes of tasks. Thus, the threshold is met when a task is removed and the estimated time of the remaining tasks in the queue add up to less than 5 minutes. Thus, the threshold is met and a further task is sent to the queue. In some systems with very short tasks, this could result in a queue of 10-100 tasks, or even more. In other systems, where tasks take longer (e.g., manual plate filling), there may only be 1-3 tasks in the queue per operator.

According to an embodiment, the tasks associated with each of the plurality of job orders comprises physical tasks which need to be performed by an operator. Optionally, the physical tasks are manual plate filling orders. Such a system works particularly well when the production system involves automated components and manual components. Then, the manual or physical tasks can be dynamically reprioritized until they go into a queue at a late moment for fulfilment by an operator, thereby ensuring little to no downtime between tasks and minimizing any delays in production.

According to an embodiment, the step of dynamically adjusting the priority of each job order is based on one or more of: available tablets, shipping time, a new job order, available operators/equipment, and available dispensing resources (e.g., cannister availability). The adjustment of priority of jobs can be according to any one or more of these factors or others. For example, resources, such as a feeder unit or tablets may only be available at a later time, and thus other job orders should be prioritized ahead of ones needing those particular resources. Operator(s) scheduling (e.g., amount of operators working and when) can also affect priority to ensure shipping time is met. Additionally, new information such as different weather conditions affecting resources or shipping time can be a reason for reprioritization. The method allows for such re-prioritization until a very late stage in the production process allowing for agile adjustment as new information or occurrences affect the priority of production job orders.

According to an embodiment, the step of dynamically adjusting the priority of each job order comprises reviewing each job order at regular intervals and adjusting the pending job orders list accordingly. This regular interval could be based on a time interval (e.g., every 5 minutes), when a new job order comes in, if a new job order or multiple job orders come in while reprioritizing, upon system startup or at any other time deemed useful or necessary. Such reprioritization at specific intervals of time or triggered by an event or new information ensures that the prioritization is updated dynamically and often for efficient production processes aligned with changing needs and information.

According to an embodiment, the step of dynamically adjusting the priority of each job order can be performed at any time until the job order has been sent to the queue. As the priority cannot change once the task is in the queue, only sending the task to the queue at a late moment allows for a more dynamic system able to adjust to changing priorities.

According to an embodiment, the production system comprises an automated component and one or more manual components. Optionally, the production system is a system for dispensing and packaging medicaments. Such a system which is able to dynamically change priorities of tasks until a very late moment when it is sent to the queue allows for a very efficient system which involves automated and manual components, such as a system for dispensing and packaging medicaments. The tasks can typically relate to manual or physical components, and the queue can ensure that tasks are always available for the operator to pick up which dynamically reprioritizing as often as needed until the moment they are sent to the queue and nearly ready for handling. This results in a an overall more efficient system which is able to respond more easily and quickly to events and information which change the priority of pending job orders and tasks.

According to an embodiment, the control unit comprises a message broker which is configured to receive a message from one component of the plurality of components, determine which other component(s) of the plurality of components need to receive the message, and send the message to the other component(s). Optionally, the message broker is further configured to ensure that each sent message is received by the other component(s). Further optionally, the message broker is configured to hold the message in a message queue until the other component is able to receive the message. Further optionally, the message broker determines which other component(s) of the plurality of components need to receive the message by evaluating the content and source of the message. Such a message broker system allows for different components to communicate with each other, even if not part of the same systems or devices. The message broker system is also able to ensure that messages are delivered even if sent when various components are offline by keeping in a message queue.

According to a further aspect of the invention, a computer program product comprising a non-transitory computer-readable medium holding instructions that, when executed by a processor, cause a dispensing system to perform the steps of the methods previously discussed is provided.

According to a further aspect of the invention, a, production device comprises an automated portion and a manual portion, a graphical user interface and a control unit for controlling the graphical user interface and production device. The control unit comprises a processor and a non-transitory computer-readable medium holding instructions that, when executed by the processor, cause the control unit to: receive a plurality of job orders; determine tasks associated with each of the plurality of job orders; dynamically adjust the priority of each job order in a pending job orders list; and send one of the job orders and associated tasks to a queue when a threshold associated with the system is met. Optionally, the production device is a dispensing device for dispensing discrete medicaments, wherein the dispensing device comprises a dispensing section for dispensing the medicaments, a plate fill station for manual filling of plates, a user interface and a control unit for controlling the graphical user interface and dispensing device. Such a device and system can work to ensure efficient production, allowing to dynamic adjustment of the priority of job orders and associated tasks until a late moment when it is sent to the queue for production. Such a device allows for adjusting priorities while also ensuring any downtime is minimised by always providing a queue of tasks ready for providing the next task which must be done as soon as the previous one has been completed, but also not sending the tasks to the queue (where they cannot be reprioritized) until a late moment.

According to an embodiment, the associated tasks with each of the plurality of job orders is related to manual tasks, for example, manual filling of plates. The device allows for efficient production processes with manual work and can be particularly effective when such manual work takes a significant amount of time, such as plate filling. In the time it takes for plate filling (e.g., 20-30 minutes), priorities can change and the device allows for dynamically reprioritizing until the moment a task goes into the queue, allowing for easier and quicker responses to changing information and priorities.

According to an embodiment, the control unit is further configured to control the graphical user interface to display the associated tasks in the queue.

According to an embodiment, the threshold associated with the system relates to number of tasks allowed in the queue. Optionally, the number of tasks allowed in the queue is related to a total estimated time to complete all tasks in the queue and/or a number of tasks er operator currently working with the device. Such thresholds ensure that tasks are only sent to a queue at a late moment, thereby allowing for dynamic reprioritization until then. For example, the threshold could be related the amount of tasks which could be done in 5 minutes per operator working. Thus, for shorter tasks, there would be more tasks in the queue, for example, 10-100. If working with longer tasks (e.g., manual plate filling), the threshold may only be set to 2 tasks, even if the first task was estimated to take more than 5 minutes as the queue always needs a next task for the operator.

Optionally, the plurality of job orders which are received by the control unit could come from a queue. Such a queue could be in a database or other data storage structure, and can be populated by a job producer or other controller. Thus, the job orders being received in the methods and systems herein described could be coming from a queue and/or job producer in some embodiments.

According to a further aspect of the invention, a method of enabling communication between distinct components in a system for dispensing and packaging medicaments into pouches is provided. The system comprises a plurality of components, and the method comprises providing a broker configured to: receive a message from one component of the plurality of components, determine which other component(s) of the plurality of components need to receive the message, and send the message to the other component(s); and connecting the broker to each of the plurality of components such that the broker can receive and send messages to and from each of the components in the system. Such a method allows different components and system to interact and work well with other components (e.g., machines and/or stations not originally a part of the system) and applications to ensure an overall smooth processes for the customer, no matter their setup. The message broker allows for systems to communicate with each other and connect. The use of such a method using a message broker enables different machines and components to interact and communicate with each other to have a more flexible set-up which can also work towards overall efficient production. This also enables the customer to combine multiple systems, for example, to upgrade their tablet dispenser but still use an older inspection machine from a different manufacturer while maintaining accuracy, efficiency and service.

According to an embodiment, the broker is further configured to ensure that each sent message is received by the other component(s). Optionally, the broker is configured to hold the message in a queue until the other component is able to receive the message. Further optionally, the broker determines which other component(s) of the plurality of components need to receive the message by evaluating the content and source of the message. Such features ensure that messages are sent and received by the correct components in a variety of circumstances, including when one or more components are offline.

According to a further aspect of the invention, a system for a medicament dispensing and packaging system comprising a plurality of components comprises a broker configured to: receive a message from one component of the plurality of components, determine which other component(s) of the plurality of components need to receive the message, and send the message to the other component(s); and a plurality of connections between the broker and each of the components of the plurality of components. Such a system using a message broker and connections to different components enables different machines and components to interact and communicate with each other to have a more flexible set-up which can also work towards overall efficient production. This also enables the customer to combine multiple systems, for example, to upgrade their tablet dispenser but still use an older inspection machine from a different manufacturer while maintaining accuracy, efficiency and service.

Optionally, the plurality of components comprise two or more of: a dispenser; a pouch inspection machine; a visual inspection station; a plate filling station, a dispatch station, a pouch packaging planning system; a stock management system, and a production job planning system.

According to a further aspect of the invention, a system for dispensing and packaging individual medicaments into pouches comprises a dispenser for dispensing and packaging the medicaments into pouches; an inspection machine for inspecting the pouches formed; optionally a visual inspection station for visually inspecting pouches formed; optionally a plate filling station for loading medicaments into a plate to be dispensed in the dispenser; optionally a dispatch station for dispatching pouches; optionally a pouch planning system for planning what pouches will be created; optionally a production planning system for planning production jobs for the dispenser; and a control system comprising a broker configured to receive a message from the dispenser, inspection machine and any optional component, determine which other component(s) need to receive the message, and send the message to the other receiving component(s). Optionally, the broker is further configured to queue the message if the receiving component(s) is offline, and deliver when the receiving component(s) is able to receive the message.

### BRIEF DESCRIPTION OF THE DRAWINGS

FIG. 1 shows an isometric view of the dispensing device with a dispensing section, a collection section and a packaging section according to a first embodiment;

FIG. 2A show a top view of the dispensing device according to FIG. 1;

FIG. 2B shows a front view of a first feeder unit at a feeder position of the dispensing section, as indicated by the arrow connecting FIG. 2B with FIG. 2A;

FIG. 3 shows a screen of a graphical user interface providing a queue of pending tasks for the operator and a timeline estimating the length of time to finish such tasks;

FIG. 4 schematically shows an embodiment of a process for dynamically ordering tasks in a system for dispensing and packaging medicaments;

FIGS. 5A-5C depict a process of reordering job orders; and

FIG. 6 schematically depicts a message broker system for a system for packaging medicaments.

### DETAILED DESCRIPTION OF THE INVENTION

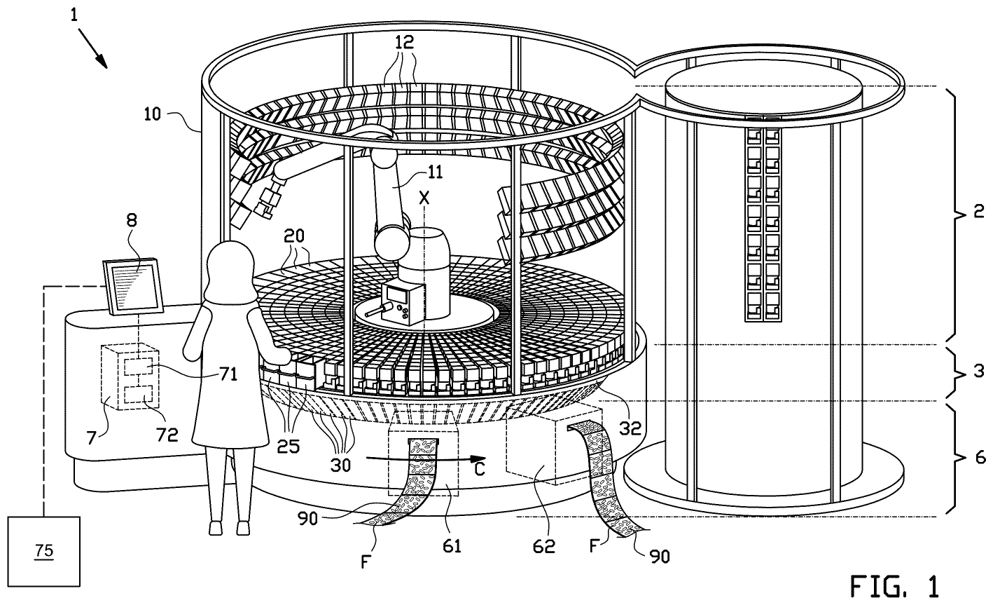

FIG. 1 shows a dispensing device 1 according to a first embodiment for dispensing discrete medicaments, discrete solid medicaments, pharmaceuticals or solid items, articles or substances 90 for medical use, e.g. pills, tablets, capsules or the like. The medicaments are ‘discrete’ in the sense that they can be dispensed one-by-one, individually, separately or in dose units.

The dispensing device 1 comprises a dispensing section 2 for dispensing the medicaments 90, a collection section 3 for collecting the medicaments 90 from the dispensing section 2, a packaging section 6 for packing the medicaments 90, and a manual fill station 75 for manually filling plates (depicted schematically). The collection section 3 is located below or vertically below the dispensing section 2. The packaging section 6 is located below or vertically below the collection section 3. The dispensing device 1 further comprises a housing 10 for shielding the aforementioned sections 2, 3, 6 from unauthorized access.

The dispensing section 2 defines an array of feeder positions 20 for receiving or holding a plurality of canisters, tablet cases or feeder units 40. Each feeder position comprises a docking member for mating with or receiving a respective one of the feeder units 40, with an appropriate aperture or channel to allow passage of dispensed medicaments 90 through the feeder position 20 into the collection section 3 underneath. The array of feeder positions 20 is distributed along an endless collection path Z1. In this example, the endless collection path Z1 is circular or substantially circular and the array of feeder positions 20 is distributed circumferentially about a rotation axis X. More in particular, the array of feeder positions 20 is distributed circumferentially or according to a radial grid, e.g. in a plurality of radially extending rows arranged side-by-side or adjacent in a circumferential direction about the rotation axis X. Preferably, the housing 10 extends cylindrically around the array of feeder positions 20. In this example, the circumferential walls of the housing 10 are provided with a plurality of stock positions 12 for holding temporarily unused or auxiliary feeder units 40.

The dispensing device 1 is further provided with a robotic manipulator 11, e.g., which can include a robot arm, for automatic, automated or autonomous handling, positioning, removing and/or repositioning the feeder units 40 with respect to the array of feeder positions 20. The robotic manipulator 11 is provided with a gripper head to pick-and-place the feeder units 40. In this embodiment, the robotic manipulator 11 is located at the center of the array of feeder positions 20, e.g. close to, at or near the rotation axis X. In said position, all feeder positions 20 and stock positions 10 are conveniently within reach of the robotic manipulator 11.

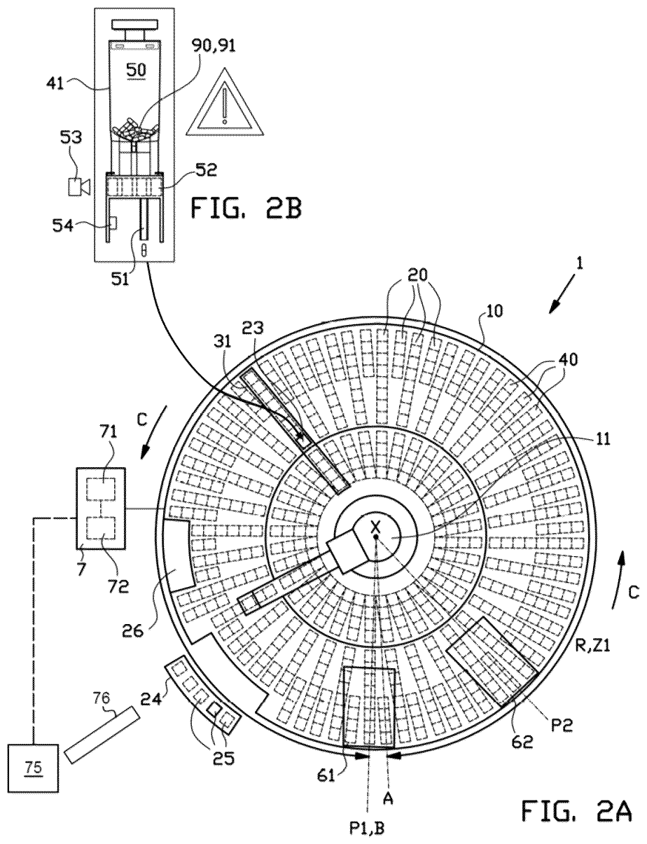

FIG. 2B show a feeder unit 40 of the plurality of feeder units 40 in more detail. The description of the feeder unit 40 hereafter is representative for all feeder units 40 of the plurality of feeder units 40.

As shown in FIG. 2B, each feeder unit 40 comprises a container 50 for holding an amount of the medicaments 90 with a composition 91 specific to said respective feeder unit 40. The term ‘composition’ is to be interpreted as the chemical or pharmaceutical composition of the medicament 90, e.g. the combination of active ingredients, that could include slight variations. Each feeder unit 40 typically only holds a medicaments 90 of a single composition. The container 50 has a volume that may hold several hundreds or more (or less) of the medicaments 90, depending on their size and shape.

Each feeder unit 40 further comprises an outlet 51, e.g. a fall pipe, for dispensing the medicaments 90 towards the collection section 3 and a dispensing mechanism 52 between the container 50 and the outlet 51 for controlled feeding of the medicaments 90 from the container 50 into the outlet 51. In this embodiment, the dispensing mechanism 52 comprises a wheel that acts as a revolving door to singulate and feed the medicaments 90 one by one towards the outlet 51. It will be apparent to one skilled in the art that alternative dispensing mechanisms may be provided which can singulate the medicaments 90.

Each feeder unit 40 may further be provided with one or more sensors 53, 54, e.g. a vision camera, a photosensor, a laser sensor, a level sensor, a weight sensor or the like, for verifying the type, composition and/or integrity of the medicaments 90, and for counting the amount of medicaments 90 that have been dispensed.

As best seen in FIG. 1, the dispensing section 2 further comprises a feeder loading member 24 with a plurality of feeder loading positions 25 for receiving new feeder units 40 into the dispensing device 1 and/or for removing feeder units 40 from the dispensing device 1. In this example, the feeder loading member 24 is formed as a drawer. Alternatively, a door or the like may be used. The dispensing section 2 also comprises a manual loading position 26 for receiving a manual loading member, e.g. a medicine transport plate, that has been manually loaded with medicaments 90 at manual fill station 75. This is used when a job order requires medicaments 90 which are unsuitable to be dispensed automatically with the aforementioned feeder units 40.

As further shown in FIG. 1, the collection section 3 comprises a plurality of collection units, in particular collection hoppers 30, which are open at a side facing the dispensing section 2 to receive selectively dispensed medicaments 90 from one or more of the feeder units 40. In this example, each collection hopper 30 extends underneath a plurality of feeder units 40 at the same time to receive the medicaments 90 from any of those feeder units 40. Each collection hopper 30 tapers towards the bottom and is provided, at said bottom, with a valve (not shown) that can be operated to drop the collected medicaments 90 into the packaging section 6.

In this embodiment, the plurality of collection hoppers 30 are distributed circumferentially about the rotation axis X. More in particular, the plurality of collection hoppers 30 are held in a collection frame 32 that is movable along the endless collection path Z1, e.g. by rotating about said rotation axis X to move the plurality of collection hoppers 30 relative to the array of feeder positions 20 in the dispensing section 2. The rotation may be a stepped rotation, wherein each step aligns the plurality of collection hoppers 30 with a next group of feeder units 40 in the array of feeder positions 20. Each collection hopper 30 extends radially along a row of radially arranged feeder positions 20.

In normal operation, the collection frame 32 is rotated one-way in a collection direction C along the endless collection path Z1 so that each collection hopper 30 can make a full revolution of three-hundred-and-sixty degrees, about the rotation axis X and visit all feeder positions 20 of the array of feeder positions 20, though in some embodiments the rotational movement could be more limited.

The packaging section 6 comprises a first packaging unit 61 at a first packing position or a first angular packing position Pl about the rotation axis X. Optionally, the packaging section 6 may comprise a second packaging unit 62 at a second packing position or a second angular packing position P2 to increase the packing efficiency of the dispensing device 1. The valves of the collection hoppers 30 are operated when a respective one of the collection hoppers 30 is in a position overhead or directly above a selected one of the packaging units 61, 62 to drop the collected medicaments 90 into the respective packaging unit 61, 62. Each packaging unit 61, 62 comprises a stock member for holding the packaging material, in this example a foil, a printer for printing information about the medicaments 90 on the foil, a filling member for positioning the foil to receive the medicaments 90, a seal member for forming a pouch around the received medicaments 90, a perforation member for providing the foil with perforations between subsequently formed pouches and an output member for outputting the packaged medicaments F from the dispensing device 1.

Alternatively, one of the packaging units 61, 62 or both may be arranged for packaging the medicaments 90 in a storage material other than a foil, e.g. in vials, bottles or cards.

The first packing position PI and/or the second packing position P2 can be fixed relative to the rotation axis X, at least during the dispensing operation.

As shown in FIG. 1, the dispensing device 1 is further provided with a control unit 7 that is operationally and/or electronically connected with the robotic manipulator 11, the feeder units 40, the packaging units 61, 62 and other electronic equipment such as drives, sensors and the like, to control the operation of the dispensing device 1. The control unit 7 comprises a special purpose processor 71 and a computer-readable medium 72 holding computer-readable code or instructions that, when executed by the processor 71, cause the dispensing device 1 to operate according to the methods described in more detail hereafter. The computer-readable medium 72 is non-transitory or tangible, e.g. a physical data carrier such as a hard-drive, a USB-drive, a RAM memory or the like.

The dispensing device 1 may further be provided with a graphical user interface 8, for example a screen, to provide a human operator with useful information about the dispensing, collection and packing operation. This can include, but is not limited to, a queued list of job orders and/or associated tasks for fulfillment of the job orders.

Methods of operating the dispensing device 1 will be described hereafter with reference to the plurality of feeder units 40, a first collection hopper 31 of the plurality of collection hoppers 30 and the first packaging unit 61 of the two packaging units 61, 62 only. It will be clear to one skilled in the art that the dispensing device 1 can be operated in substantially the same way for any other selection of the feeder units 40, the collection hoppers 30 and/or the packaging units 61, 62 to ensure a flexible and substantially uninterrupted or continuous dispensing, collection and packing process.

As shown in FIGS. 2A, the first collection hopper 31 is rotatable with respect to the array of feeder positions 20 in a collection direction C about the rotation axis X between a start position or an angular start position A downstream from the first packing position P1 in the collection direction C and an end position or an angular end position B at or near, in this case, above the first packing position P1. In other words, the first collection hopper 31 is rotatable about the rotation axis X over a collection range R that starts at the angular start position A and that ends at the angular end position B. In this example, the collection range R is five degrees short of three-hundred-and-sixty degrees, almost a full revolution.

When the control unit 7 receives a job order for dispensing and packaging medicaments 90, the control unit 7 determines which feeder units 40 to use, based on the specific current or remaining amount of medicaments 90 in said feeder units 40 and determines if the job order requires any manual filling of plates and/or other associated tasks (e.g., new feeder units).

The control unit 7 may be configured to store on the computer-readable medium 72 the specific job order and associated tasks. Generally, the control unit 7 would then place the job order at the end of the pending job orders list in the control unit to be fulfilled. In some instances, for example, when the job order received is marked as urgent, the control unit 7 would adjust the priority of job orders stored on the computer-readable medium 72 to allow for the urgent job to be performed sooner than non-urgent job orders, thereby creating a newly prioritized list of all pending job orders. Thus, the priority of each job order can be dynamically adjusted continuously or at specific intervals (e.g., set intervals of time, whenever a new order or new information is received regarding an existing order).

The associated tasks related to the specific job order can be physical tasks, such as manual plate filling or may be other tasks such as starting a program or process. Such manual plate filling is very time consuming (compared to the production of pouches with medicaments from feeder units), sometimes taking an operator 20-30 minutes to manually fill a plate. The control unit 7 sends the manual plate filling task to the operator via the graphical user interface 8, showing the operator the manual filling operation needed next for the next job order to be completed.

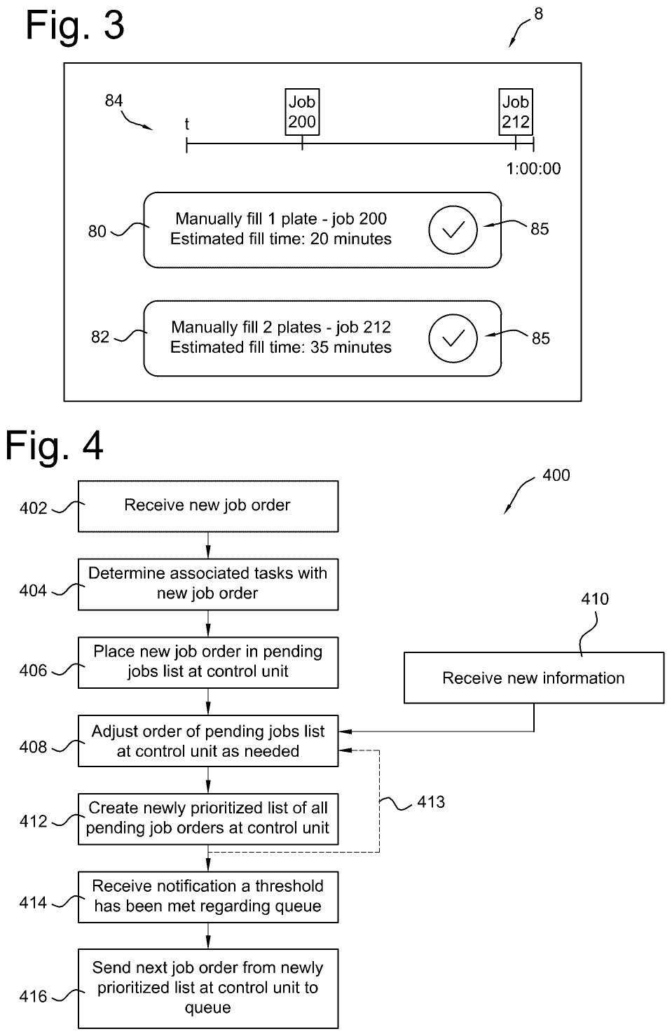

To ensure that the next associated task is always available as soon as the previous task has been finished (e.g., the next manual fill plate order is ready to be started as soon as the operator has finished the last one), the control unit 7 sends the associated task into a queue. The queue displays the current task and all other tasks in the queue via the graphical user interface 8 (see FIG. 3), and the operator can simply mark the current task as done as soon as it has been completed. Once completed, it will be removed from the queue on the graphical user interface, all remaining tasks will move up in the queue for being performed, and the control unit 7 will send a further task to the queue to be placed at the end of the queue (the top priority from the newly prioritized pending job orders list at the control unit 7).

The threshold for tasks in the queue can be manually set in advance and/or adjusted as needed (e.g., an additional operator comes to work with the system or one operator leaves). In some embodiments, the threshold could be constantly monitored and automatically set and/or adjusted. In other embodiments, the threshold could be set according to the schedule of subscribers or operators who will work at certain times. The threshold could also be set according to a total amount of time for tasks in the queue. For example, the queue is set to have 5-10 minutes of tasks in the queue and dynamically adjusts the amount of tasks in the queue according to an estimated time for completion of each task. If shorter tasks are in the queue, for example, the queue may consist of 10 tasks, whereas if longer tasks (e.g., manual plate filling) are in the queue there may only be two tasks in the queue. At a minimum, there must be two tasks in the queue such that there is always another task prompted for the operator to start when a current task has been completed.

FIG. 3 shows the graphical user interface 8 of the aforementioned dispensing device 1 in more detail. The graphical user interface 8 is generated by the control unit 7. As shown in FIG. 3, the graphical user interface 8 presents the human operator with a queue of tasks for fulfilling job orders, in this case manual plate filling tasks 80, 82 are shown. Optionally, a timeline 84 is also shown estimating the timeline for each of the tasks. The plate filling tasks 80, 82 may be provided on the timeline 84 and/or separately from said timeline 84. The timeline 84 has a time axis t from left (current time) to right (future). The plate filling tasks 80, 82 are estimated by the control unit 7. In this case, one operator is currently working with the system, and two tasks are shown in the queue. If more operators or subscribers were working, more tasks would be shown, for example, 4 tasks for two operators. The amount of items in the queue can also be dynamic related to the number of subscribers or operators related to that queue and the specific tasks and the estimated completion times of those tasks. These are examples only and a different number of tasks could be used in the queue related to the number of operators.

The operator performs work on the first task 80, preparing the manual fill plate for job 200. Specific instructions for the tablets needed and manual filling will be provided to the operator at the manual fill station 75. Once the operator has completed the manual fill plate associated with first task 80, he can indicate the completion via the graphical user interface, for example, by pressing completion check button 85.

In the system shown and described, control unit 7 only sends a task to the queue when it has been determined that a threshold has been met. This threshold is related to the number of tasks in the queue and/or estimated total time of tasks in the queue, and ensures that there is always a next task available to be started, but that there are not too many tasks in the queue such that the job orders can be dynamically adjusted in priority until the last possible moment before fulfillment. This threshold can be related to the number of operators currently working with the system and/or estimated total time of tasks in the queue, for example, the threshold can be set such that the queue should always have two associated tasks per operator or that there is always 30 minutes of tasks in the queue. Thus, in a system with only one operator working with a threshold of two tasks per operator, if a task is finished by the operator and only one task remains in the queue, the threshold is met and the control unit 7 sends the highest priority next associated task/job to the queue. This enables the system to adjust the priorities according to new job orders and/or new information (e.g., availability of tablets, urgency of order, changed shipping time, availability of resources) until a moment very near to when the next job order and associated tasks will be started. Thus, the control unit 7 is able to throttle the job orders and dynamically adjust priorities until a moment very close to when they are to be started before sending them to a queue for execution.

Past systems simply determined tasks associated with job orders and sent them to the queue in the order in which they were received. However, once in the queue, there is no ability to change the order or priority and thus there was no ability to adjust as circumstances changed. The current system overcomes these difficulties by dynamically adjusting the priority of job orders and tasks at the control unit and only approving them to be sent to the queue once a threshold is met related to a minimum number of tasks or total time for tasks in the queue. Only at such a late stage is the order/task finalized and sent to the queue, and thus the system allows for more flexibility in adjusting priorities as circumstances change.

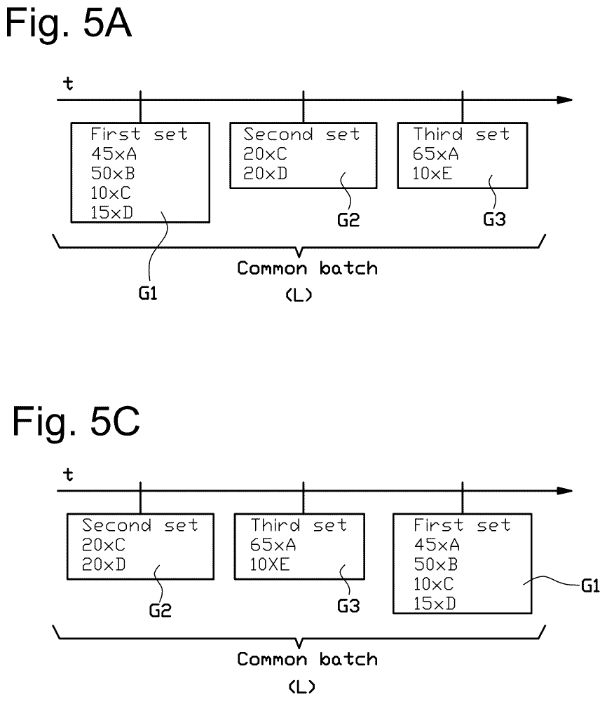

A specific example of this process 400 is depicted in FIG. 4. First a new job order is received by the control unit (step 402). This typically consists of an order for a certain number of pouches which each contain a specific set of medicines. This could be the same specific set of tablets for each pouch or could vary.

When the new job order is received, the control unit 7 then determines associated tasks for the new job order (step 404). In this example, the specific associated tasks determined for the job order are the manual fill plates needed and estimated time for an operator to manually fill such plates, though this could include other parameters in other embodiments.

In step 406, the new job order (and associated tasks) are placed in the pending jobs list at the control unit. The pending jobs list includes all jobs which are scheduled to be performed by the system but which are not yet started and not yet in the queue. In some cases, this can be hours or days of job orders scheduled to be performed.

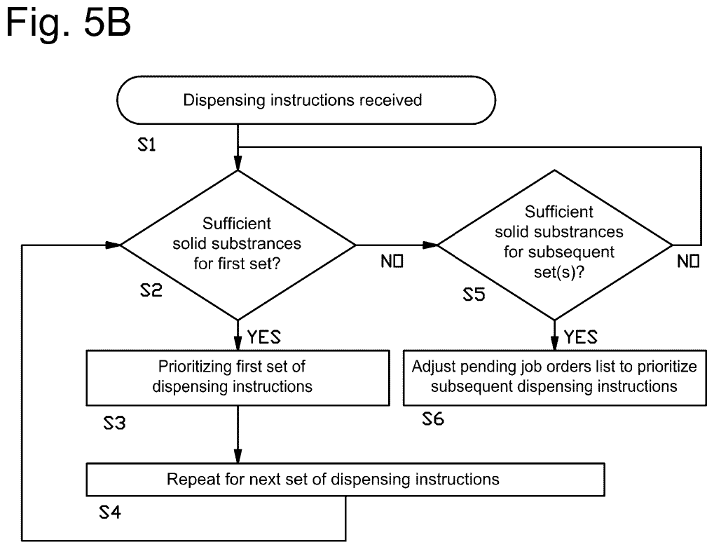

Step 408 then adjusts the order of pending jobs at the control unit as needed, taking into account any new information received since the last adjustment and newly prioritized list was created (step 410). Such information can include, but is not limited to: a specific job order needing to be shipped earlier or later than previously thought (e.g., due to weather conditions affecting transport), tablets for a specific job order not being available until a later moment, a feeder unit needing to be refilled; a job order requiring a lot of manual plate filling and only one operator is available at certain times for the system; availability of dispensing resources (e.g., specific feeder units are only available later), etc. A specific example of new information and adjusting to create a newly prioritize list of pending jobs at the control unit is detailed in relation to FIGS. 5A-5C.

Next, a newly prioritized list of all pending job orders is created at the control unit (step 412) taking into account any adjustments related to the new job order and/or new information. Dashed line 413 shows that these steps 408 and 412 of adjustment and creation of a newly prioritized list at the control unit can be performed additionally, for example, at regular intervals instead of or in addition to when a new order or new information is received. The intervals could be based on, for example, a unit of time (e.g., every five minutes or every hour); a new order coming in; when there is a change in operator or change in number of operators; the startup of a new machine, or any other related events or circumstances.

In step 414, the control unit 7 receives a notification that a threshold at the queue has been met, indicating that the first order in the most recent newly prioritized list should be sent to the queue (step 416). As discussed above, the threshold in the queue is typically related to the number of tasks per operator and/or a total amount of time for completion of all tasks in the queue. Using the queue shown in FIG. 3, one operator is working with the system currently and two tasks 80, 82 are shown in the queue at one time. When the operator completes one (manually fills the plate for job 200, possibly including delivery and presentation to dispensing system for use) and presses check button 85 on the graphical user interface 8, that task is removed from the queue (as it has been completed), and task 82 moves up to the top place for the operator to start working on.

The control unit is also notified that the threshold has been met because there is only be one task 82 left in the queue and the threshold is to have two tasks in the queue per operator currently working. The notification informs the control unit 7 that it should send another task to the queue so that it is ready to be started as soon as the operator has completed task 82, preparing the two manual fill plates related to job 212. The new task would be the top task/job from the newest prioritized list of pending job orders at the control unit 7, and the task would be placed at the bottom of the queue (in the place where task 82 is currently shown). The estimated timeline would also be updated as the tasks are marked completed and new tasks are added to the queue.

Thus, process 400 allows for dynamically adjusting tasks (particularly manual tasks) to respond flexibly when priorities change, thereby allowing for a reprioritization of job orders. This helps to ensure that the overall system works efficiently, minimizing downtime and responding to new orders and/or information. The queue ensures that the operator always knows the next task (and can therefore start immediately upon completion of one task) while the pending jobs list and continuous (or at intervals) adjustment and reprioritization of the pending jobs list at the control unit 7 allows for changing priorities when circumstances change. Thus, the overall system can be more accurate and efficient to suit the needs of pending job orders at any time.

FIGS. 5A, 5B and 5C are related to a method for dispensing the medicaments 90 with the use of the aforementioned dispensing device 1, including an example of steps for changing the order of pending jobs G1, G2, G3 in view of new information.

In particular, FIG. 5A shows a first set of dispensing instructions G1 requiring forty-five times a medicament 90 of a composition A, fifty times a medicament 90 of composition B, ten times a medicament 90 of composition C and fifteen times a medicament 90 of composition D. Similarly, a second set of dispensing instructions G2 and a third set of dispensing instructions G3 are provided which require a different amount of medicaments 90 of similar compositions C, D or different compositions E, F. It is originally intended that the control unit 7 orders these in a pending jobs list to be sent to a queue (when the threshold has been met) for the processor 71 to execute the sets of dispensing instructions G1, G2, G3 in the order as shown, from left (current time) to right (future) along a time axis t.

FIG. 5B shows a diagram of the steps of a method to be performed by the processor 71, for determining an alternative order for the pending jobs list, and then sending to a queue for executing the sets of dispensing instructions G1, G2, G3 when the first set of dispensing instructions G1 cannot be completed with the medicaments 90 remaining in the plurality of feeder units 40 (the new information).

In particular, the method comprises the steps of receiving the sets of dispensing instructions G1, G2, G3 (step S1) and prior to sending the instructions to the queue for executing the first set of dispensing instructions G1, determining or receiving information regarding whether the plurality of feeder units 40 contain sufficient readily available medicaments 90 to complete the dispensing of the first selection and the first amount of medicaments 90 in accordance with the first set of dispensing instructions G1 (step S2). The medicaments 90 are ‘readily available’ if there sufficient medicaments 90 left in the plurality of feeder units 40 which are cleared to be dispensed. Said clearance to send the instructions to the queue next may be revoked when the medicaments 90, at the time of dispensing or administration, would be beyond the expiry date registered in the system. In the affirmative, the control unit 7 may proceed to send the first set of dispensing instructions (step S3) to the queue, and then repeat the determination for each subsequent set of dispensing instructions (step S4).

However, if information is received that the plurality of feeder units 40 contain insufficient readily available medicaments 90 to complete the dispensing of the first selection and the first amount of medicaments 90 in accordance with the first set of dispensing instructions G1, the control unit 7 switches to adjust the order of pending jobs, sending one or more sets of the one or more further sets of dispensing instructions G2, G3 (step S6) to the top of the pending jobs list for sending to the queue first when a threshold is met. Optionally, this can be preceded by a determination or receiving information regarding whether the feeder units 40 contain sufficient readily available medicaments 90 to complete the dispensing of the selection and amount of medicaments 90 associated with each subsequent further set of dispensing instructions G2, G3 (step S5). Hence, the order in which the sets of dispensing instructions G1, G2, G3 are executed can be changed, as shown in FIG. 5C.

During the executing of the one or more further sets of dispensing instructions G2, G3, an action can be taken to ensure that the system is ready to complete job order G1, for example, replacing needed medicaments. In particular, a human operator may be notified to replace or supplement the affected feeder units 40.

In the event that there are insufficient readily available medicaments 90 to complete dispensing according to any one of the sets of dispensing instructions G1, G2, G3, the control unit 7 will return to the determination of step S2 and wait for the medicaments 90 to be supplemented.

In some cases, the first set of dispensing instructions G1 and one or more of the one or more further sets of dispensing instructions G2, G3 could share a logistical parameter L that link the first set of dispensing instructions G1 and the one or more further sets of dispensing instructions G2, G3 to a common batch. The control unit 7 could then be restricted to changing the order of the sets of dispensing instructions G1-G3 within the common batch only and not with respect to any other orders on the pending jobs list at the control unit. The logistical parameter L may be a delivery address, a patient order, a client name or the like.

While a specific embodiment of a dispensing device is shown in FIG. 1, this is an example, and the methods and/or systems discussed herein can be flexible and able to work with other production systems, particularly any which involve automated components and manual work.

Additionally, the systems and methods can work with discrete different components, facilitate communication between the components and consider the overall system needs when planning and executing jobs or orders. The control unit 7 or a separate operating system (hereinafter referred to as “the control system”) can be the driver of any or all of the various processes and devices/components involved, and can allow for flexibility in any part the processes, for example, in planning and execution logistics, inspection processes, correction processes, shipping, and even interacting with other software, processes, systems and/or machines. Such variations in the processes and workflows are discussed below for example purposes, and further variations could be included when desired.

The control system can cover most or all of the logistical process of producing pouches as well as guide any operators through all processes (thereby reducing human error). Such processes can include (but are not limited to):
Preparing plate medication on plate fill stations guided by the system
Preparing medication for cannisters and/or preparing the cannisters themselves
Producing pouches on a tablet dispenser
Inspecting pouch content on a pouch inspector
Visually evaluating pouch images of pouches that have been rejected by the pouch inspector
Splitting produced pouch strings into medication rolls, for example, per patient or another discriminator such as administration time/department-note that this can be combined with inspecting pouches on inspection machines that offer both functionalities
Correcting pouches that have production errors, either manually or automatically
Sending and evaluating images that have been made of the corrections (either manually or automatic)
Packaging and shipping the medication rolls to the end customer or patient
Generating reports related to any aspect of the process, including the orders, production and/or hardware

The control system can also track and trace all operations that are carried out, thereby providing an audit trail.

Unlike past devices or systems which could typically only physically configure the machines or devices according to customer request, but ran a standard process, the configuration of the current control system ensures that even the processes are highly flexible and can be arranged to suit different customer needs or desires, combining and configuring different components in the way that each individual customer desires. By having a central point of configuration, the overall process itself (and various sub-processes) can be personalized for the customer. A number of specific features help to support this:
All applications can be configured in a central management application.
The process itself can then be configured using process templates that define which stages are to be used (and which are not needed, for example due to other software running a specific component and/or system), which can also include details such as which print layouts are to be used for the pouches, the maximum number of medicines to package into a single pouch, etc.
For every step and operator action in the process, a central security module can be used to specify who and/or what component is allowed to perform those actions, and guide the operator to ensure they are performed correctly. Using this, it is possible, for example, to make sure that only pharmacists or another high level supervisor can manually correct a pouch (which has a defect) or bypass a barcode verification.

This way, the process is able to be configured to ensure that legal, local and/or internal regulations are complied with.

### Everything can be Prioritized on Shipping Time

The control system can also configure all processes to ensure that pouches are shipped out in time for use through arranging the logistics of various processes and systems, and can also accommodate customer preferences for production order and priorities. This can be done, for example, by one or more of the following steps:
With each order, a required shipping time can be specified (e.g., by the application that submits the order to the system).
The system makes sure that orders are released to production (e.g., sent to a tablet dispenser) in time to meet those specified shipping times.
Orders can also be marked (e.g., by the application that submits the order to the system) as an emergency (express) order. The system then plans to handle those orders with the highest priority, adjusting the order of the pending jobs list at the control unit and reprioritizing as needed, as described above.
The required shipping time can be shown (e.g., on one or more graphical user interfaces) to the operators of all involved components and systems, for example, tablet dispensers, plate fill stations, correction stations and dispatch stations.
For efficient production, the medication rolls of multiple orders can be combined into a single production job that is assigned to a tablet dispenser. The priorities of these jobs can then be determined by the earliest shipping time of the orders that are part of those jobs, and the system can plan and execute these production jobs accordingly.
When two or more orders have the same or a similar shipping time specified, their priority can be determined based on the moment the orders have been received. By handling them on a first-in-first-out (FIFO) basis, the application that submits the orders to the system has control over the priority, which can be useful for the customer to be able to place requests in the order that they want them prioritized.
The above described method of throttling orders and only sending to a message queue for execution at the last minute can ensure that any changes to priority are realized and executed as late as possible with little to no interruption of the production of pouches.

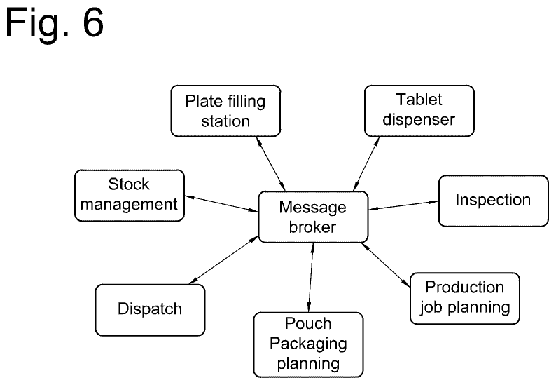

Through the control system, components and processes are designed to interact and work well with other components (e.g., machines and/or stations not originally a part of the system) and applications to ensure an overall smooth processes for the customer, no matter their setup. For example, the customer could have a number of different components from different manufacturers that need to be able to interact with each other. Such a set-up could have the tablet dispenser device being separate from a manual plate filling station component, with further distinct inspection, stock management, dispatch and planning components, with one or more of these devices/components being connected by conveyors and/or robots for transfers. The control system is able to interact with each of these components to drive some or all of the processes through a message broker system. Such a system is shown schematically in FIG. 6.

As shown in FIG. 6, the message broker facilitates interaction and communication of the different applications with each other. A message is sent to the broker and a configuration within the message broker can determine the other applications to which this message is to be sent, and then sends the message.

For example, production results (e.g., data on produced pouches and their contents) from a tablet dispenser are sent to the message broker, and the message broker then determines that these production results need to be sent to the inspection machine, the planning system, and the stock management based on the content of the message and information stored in the message broker (or other accessible memory related to what messages need to be sent to what components/applications). The message broker then forwards the production results received from the tablet dispenser to those identified components, the inspection machine, the planning system, and stock management.

The message broker can also ensure that the message/data is actually received by all identified components/applications. For example, if in the above example, the inspection machine was offline when the production results were received, the message broker could send the message immediately to the other two components, but store it in a message queue waiting for the inspection machine to come back online. Once the message broker senses or is informed the inspection machine is back online, the message broker takes the message from the message queue and sends it to the inspection machine.

Thus, the use of a message broker enables different machines and components to interact and communicate with each other to have a more flexible set-up which can also work towards overall efficient production. This also enables the customer to combine multiple systems, for example, to upgrade their tablet dispenser but still use an older inspection machine (e.g., from a different manufacturer) while maintaining accuracy, efficiency and service.

Functionality of the control system can also be implemented in microservices: relatively small applications that provide a certain specific functionality. With each software installation these microservices can be replaced with other implementations to create an ideal fit for the customer. The communication to and from the message broker can be wired or wireless communication, or can be a combination of the two.

Various components which the message broker could facilitate communication with and between could include, but are not limited to:
a dispenser—for producing pouches and sending results
a pouch inspector machine—which publishes inspection results
a visual inspection—where a person reviews images and/or pouches which have been rejected and/or corrected—publishes evaluation results
a pouch packaging planning component—which decides what pouches will be produced based on an order received, receives orders and/or publishes a pouch packaging plan
a production job planning component—creates a production job from a pouch packaging plan

Further, the control system can also help to ensure proper load balancing on a site which has more than one dispensing system. On such a site, when an order is received, it must be determined which dispenser is going to produce the medication rolls for the incoming order. The control system is able to flexibly work to plan the logistics of this to balance the loads, taking into account efficient processing of orders, availability and location of medicines, etc.

The choice of which dispenser to use for an order impacts both the time that the medication rolls will be ready as well as the amount of medication which must be manually filled onto a plate (and delivered to a dispenser) that is needed. This is in part due to the tablet dispensers not all having the same feeder unit assortment. When a dispenser does not have a feeder unit for a certain medicine and it is asked to produce pouches containing that medicine, those tablets need to be supplied to the dispenser using plates (which is slower, more cumbersome for operators and more error prone due to the manual work involved). The control system can arrange for orders to be sent to specific dispensers which minimize the time for production and/or manual plate medicines needed.

The control system can also assign feeder units of medicines to a single dispenser, a group of dispensers or no dispenser, in which case the feeder unit can be used by all dispensers (and transferred by an operator or robotically). Such assignment can be useful in efficient planning, for example, allowing more than one dispenser to share a cannister instead of requiring a plate (and consequently slowing down the production due to the time for manually preparing the plate).

Thus, the control system can provide automatic load balancing over all dispensers to minimize the amount of plate medication needed while still ensuring that all medication rolls are produced in time (with regards to the requested shipping time).

The control system can also help to group smaller orders into production jobs for greater production efficiency. Tablet dispensers such as that shown in FIG. 1 usually work most efficient when running large jobs, i.e. when they can produce a large number of pouches in one ‘run’ without the need to stop between jobs. However, orders coming in from pharmacies are usually for a rather small number of patients; typically ranging from five to thirty patients. To get to an efficient production, the control system allows orders from different pharmacies to be combined into larger production jobs to create medication rolls for many patients, sometimes more than 200. The grouping of orders into production jobs differs per installation and can take order shipping times, available medication, canister assortment, plate usage (total overall and/or specific numbers per job) and more into account.

The control system is also able to flexibly plan for batch production or free production, or a mixture of both depending on the needs of the customer at different times.

In batch oriented environments, medication rolls that have to be shipped at the same time and to the same delivery address are kept together during the whole production process: for example, the system receives an order for twenty medication rolls. The system then makes sure that these twenty medication rolls arrive at the packing and shipping area in one crate. All rolls can be produced on the same tablet dispenser, inspected on the same inspection machine, and so on to keep the batch together.

In a free production environment, every medication roll is looked at individually (instead of as a batch as described above) and the production job is planned with the most efficient production possible, ignoring which rolls need to be shipped together. This can often lead to the most efficient production (e.g., the least need for plate medication), but it is then up to the customer to take care of collecting all medication rolls in the packaging and shipping (or other) area; and preparing them to be sent to the same address (if applicable).

The control system can also facilitate and guide inspection and correction in the pouch packaging and production. Inspection and correction are an important part of any dispensing process, and can vary greatly depending on the level of automation, inspection requirements, available personnel, etc. The control system is flexible enough to accommodate and adapt to the desires and requirements of the customers for inspection and correction.

When a manual correction is made at a correction station (e.g., because a pouch has too many or too few tablets in it), this must typically be approved before sending for shipping. Typically the correction station can be operated by pharmacists as well as pharmacist technicians, and the control system can help to ensure that the pharmacist, a supervisor (or another second pair of eyes) is involved when necessary.

For example, it may be required that a pharmacist, supervisor or simply another person approves any correction before the medication roll is sent to the patient. When the correction station is operated by pharmacist technicians, a picture can be made of the manually corrected pouch in the correction station. This picture can then be sent to a visual inspection station (e.g., a location or simply a software application with a user interface) where another person (e.g., pharmacist, supervisor) evaluates and approves the correction, thereby complying with the requirements for correction approval without requiring multiple people to be at the correction station. This can be facilitated by the message broker as described above. Thus, the control system can also help to ensure that requirements and/or guidelines for inspection and correction are followed.

Further, when a possible defect is flagged (e.g., by an automatic system or a visual inspection), for example, pouches have too many or too few tablets, they are typically corrected at a correction station as described above. However, sometimes pouches cannot be corrected this way, and need to be reproduced through the dispensing machine. For most systems, re-producing pouches is a cumbersome process because it leads to very small production jobs which are inefficient to produce for a tablet dispenser. However, the control system allows for the production of these pouches to be combined with regular production of other pouches. The reproductions can be separated from the regular production during the inspection and split stages of the process, thereby eliminating the need for very small (inefficient) production jobs through the use of the control system.

The control system can also provide a consistent user interface to operators for identifying the tablets handled by the operators thereby minimizing errors in the overall process. There are several stages of the logistical process where operators need to handle tablets, including in preparing plates, preparing cannisters, removing tablets from original packaging, during a correction operation when tablets are put not pouches, etc. The control system can provide a consistent user interface for identifying the tablets handled by the operators to minimize errors in such manual portions of the process.

Typically, manufacturer packages are identified by scanning barcodes and lot numbers and expiration dates are entered (automatically upon scanning or manually). The user interface for handling tablets from the manufacturer can also sometimes interface with a (national/global) drug serialization database for live medicine package verification. The serialization uniquely identifies each package of medication, for example, to detect counterfeits.

When tablets from multiple manufacturer packages are de-blistered in advance and put into temporary holding containers or feeder units, the control system can also direct this process. For example, the process can be directed such that the number of tablets inside a holding container exactly corresponds with the number of tablets that need to be put into a feeder unit to be used in a tablet dispenser. This can also help to speed up the filling of feeder units when they run empty during production.

Finally, because the control system covers all aspects of the logistical process and because all data is stored in centralized databases, the end-user can easily generate reports that cover all stages involved, from producing pouches, to pouch inspection all the way up to pouch correction and shipping. Reports can not only span multiple stages (e.g., production, inspection, correction, and so on), but also focus on differences within a single stage: how does dispenser A perform when compared to dispensers B and C in the same installation? Reports can be developed and deployed per customer request to optimally satisfy customer needs through the use of control system.

Thus, the control system disclosed provides overall flexibility to work with different components and applications for an overall smooth and efficient production process, no matter if the components are from the same manufacturer or different.

The control system can be formed of any combination of hardware and software, for example at least one special purpose processor and at least one non-transitory memory including computer program code, the at least one memory and the computer program code configured to, with the at least one processor, perform the above described processes of the system. Any combination of one or more computer readable medium(s) may be utilized as memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. One or more computers or other control units may be present as part of the system, physically, or connected remotely.

While the description refers to medicaments, tablets, etc., the devices and methods could be used for dispensing other types of solid discrete items for separation and packaging.

It is to be understood that the above description is included to illustrate the operation of the embodiments and is not meant to limit the scope of the invention. From the above discussion, many variations will be apparent to one skilled in the art that would yet be encompassed by the spirit and scope of the present invention.

1. A method of dynamically ordering tasks in a system for dispensing and packaging medicaments into pouches, the method comprising:
providing a control unit configured to:
receive a plurality of job orders;
determine tasks associated with each of the plurality of job orders;
dynamically adjust the priority of each job order in a pending job orders list; and
send one of the job orders and associated tasks to a queue when a threshold associated with the system is met,
wherein the queue provides the job orders and associated tasks in a linear list for execution; and
wherein once job orders or tasks are placed in the queue, they cannot be reordered and no changes in the order of the queue can be made except to delete upon execution.

2. The method of claim 1, wherein the threshold associated with the system comprises a set number of tasks in the queue related to the amount of operators currently working.

3. The method of claim 2, wherein the threshold associated with the system comprises a number of tasks which are estimated to take a total predetermined amount of time in the queue.

4. The method of claim 1, wherein the tasks associated with each of the plurality of job orders comprises physical tasks which need to be performed by an operator.

5. The method of claim 4, wherein the physical tasks are manual plate filling orders.

6. The method of claim 1, wherein the step of dynamically adjusting the priority of each job order is based on one or more of:
available tablets, shipping time, a new job order, available operators/equipment, available dispensing resources.

7. The method of claim 1, wherein the step of dynamically adjusting the priority of each job order comprises reviewing each job order at regular intervals and adjusting the pending job orders list accordingly.

8. The method of claim 7, wherein the regular intervals are intervals of time.

9. The method of claim 7, wherein the step of dynamically adjusting the priority of each job order can be performed at any time until the job order has been sent to the queue.

10. The method of claim 1, wherein the system comprises an automated component and one or more manual components.

11. (canceled)

12. The method of claim 1, wherein the control unit comprises a message broker which is configured to:
receive a message from one component of the plurality of components, determine which other component(s) of the plurality of components need to receive the message, and
send the message to the other component(s).

13. The method of claim 12, wherein the message broker is further configured to:
ensure that each sent message is received by the other component(s) and/or hold the message in a message queue until the other component is able to receive the message.

14. (canceled)

15. The method of claim 12, wherein the message broker determines which other component(s) of the plurality of components need to receive the message by evaluating the content and source of the message.

16. A computer program product comprising a non-transitory computer-readable medium holding instructions that, when executed by a processor, cause a production system to perform the steps of the method according to claim 1.

17. A medicament dispensing and packaging system comprising an automated portion and a manual portion, a graphical user interface and a control unit for controlling the graphical user interface and the system, wherein the control unit comprises a processor and a non-transitory computer-readable medium holding instructions that, when executed by the processor, cause the control unit to:
receive a plurality of job orders;
determine tasks associated with each of the plurality of job orders;
dynamically adjust the priority of each job order in a pending job orders list; and
send one of the job orders and associated tasks to a queue for execution when a threshold associated with the system is met,
wherein the queue provides the job orders and associated tasks in a linear list for execution; and
wherein once job orders or tasks are placed in the queue, they cannot be reordered and no changes in the order of the queue can be made except to delete items upon execution

18. The dispensing device of claim 17, wherein the associated tasks with each of the plurality of job orders is related to manual tasks.

19. The dispensing device of claim 18, wherein the associated tasks with each of the plurality of job orders is manual filling of plates.

20. The dispensing device of claim 17, wherein the control unit is further configured to:
control the graphical user interface to display the associated tasks in the queue.

21. The dispensing device of claim 17, wherein the threshold associated with the system relates to number of tasks allowed in the queue.

22. The dispensing device of claim 21, wherein the number of tasks allowed in the queue is related to a total estimated time to complete all tasks in the queue.

23.-30. (canceled)
